(19) United States
(12) Patent Application Publication
(10) Pub. No.: US 2022/0377627 A1
(43) Pub. Date: Nov. 24, 2022

(54) METHOD FOR MDAS SERVER ASSISTED HANDOVER OPTIMIZATION IN WIRELESS NETWORK

(71) Applicant: Samsung Electronics Co., Ltd., Suwon-si, Gyeonggi-do (KR)

(72) Inventors: Deepanshu GAUTAM, Bangalore (IN); Fasil Abdul LATHEEF, Bangalore (IN)

(21) Appl. No.: 17/772,014

(22) PCT Filed: Oct. 30, 2020
(86) PCT No.: PCT/KR2020/015094

§ 371 Date: Apr. 26, 2022

(30) Foreign Application Priority Data
Oct. 31, 2019 (IN) 201941044137
Oct. 16, 2020 (IN) 2019 41044137

(51) Int. Cl. H04W 36/00

(52) U.S. Cl. CPC H04W 36/0072; H04W 36/0016; H04W 36/0058

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. Accordingly, the embodiments herein provide a method for Management data analytic service (MDAS) server (100) assisted handover optimization in a wireless network (1000). The method includes periodically collecting data from a plurality of target gNBs in the wireless network (1000), and generating an analytical report for each target gNB (300) of the plurality of target gNBs based on the collected data. Further, the method includes receiving a request for the analytical report of the at least one target gNB (300) for handover from a source gNB (200), sending the analytical report to the source gNB (200). Further, the includes performing at least one corrective action suggested by the analytical report to optimize at least one target gNB (300) for handover.

### TECHNICAL FIELD

The present invention relates to a wireless network, and more specifically related to a method for Management data analytic service (MDAS) server assisted handover optimization in the wireless network. The present application is based on, and claims priority from an Indian Application Number 201941044137 filed on 31 Oct. 2019 the disclosure of which is hereby incorporated by reference herein.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In current Radio Access Network (RAN) handover specification adopts a process in which a gNodeB (gNB) (e.g. target gNB) accepts or reject a handover request, fora user equipment (UE), from source gNB. The handover request may be rejected due to inadequacy of available virtual resources and radio resources associated with the target gNB of a wireless network. The UE will try to connect to a different gNB of the wireless network until the handover request is successfully accepted by at least one gNB of the wireless network. This hit-and-trial mechanism results in wastage of UE resources and wireless network resources. Existing handover mechanisms can be optimized using a Management data analytic service (MDAS) server and minimizing chances for a probable handover failure.

Thus, it is desired to address the above-mentioned disadvantages or other shortcomings or at least provide a useful alternative.

### DISCLOSURE OF INVENTION

### Technical Problem

The principal object of the embodiments herein is to provide a method for Management data analytic service (MDAS) server assisted handover optimization in a wireless network.

Another object of the embodiments is to periodically collect data from a plurality of target gNBs in the wireless network and generate an analytical report for each target gNB of the plurality of target gNBs based on the collected data, where the analytical report comprises at least one a current resource consumption status for each of the target gNBs, and a future resource consumption status for each of the target gNBs.

Another object of the embodiments is to receive a request for the analytical report of the at least one target gNB for handover from a source gNB from the plurality of target gNBs and based on the analytical report the source gNB determines whether the target gNB is optimal for handover at present (current optimal target) or at some future point of time (future optimal target) before initiating handover procedure to save UE resources.

Another object of the embodiments is to provide recommended actions when the target gNB is not optimal for handover, the analytical report provides recommended actions to optimize the target gNB for handover (i.e. the source gNB will take measures (indicated by an MDAS server) to make the target gNB optimal (e.g. by asking Network functions virtualization (NFV) Management and Orchestration (MANO) to scale-out the target gNB)).

### Solution to Problem

Accordingly, the embodiments herein provide a method for MDAS server assisted handover optimization in a wireless network. The method includes periodically collecting, by an MDAS server (i.e. Management data analytic service producer), data from a plurality of target gNBs in the wireless network. Further, the method includes generating, by the MDAS server, an analytical report for each target gNB of the plurality of target gNBs based on the collected data, where the analytical report comprises at least one a current resource consumption status for each of the target gNBs, a future resource consumption status for each of the target gNBs, an indication on whether at least one target gNB from the plurality of target gNBs is optimal for handover at present (current optimal target) or at some future point of time (future optimal target) and at least one corrective action to optimize at least one target gNB for handover. Further, the method includes receiving, by the MDAS server, a request for the analytical report of the at least one target gNB for handover from a source gNB from the plurality of target gNBs. Further, the method includes sending, by the MDAS server, the analytical report to the source gNB.

In an embodiment, the collected data comprises a total amount of computed resource allocated to a virtual machine, a total amount of aggregated computed resource consumption at a particular point, a total amount of storage allocated to the virtual machine, a total amount of aggregated storage consumption at a particular point of time, and various radio resources and percentage of overall consumption of the various radio resources.

In an embodiment, the analytical report comprises an assigned virtual resource and radio resource of each of the target gNBs, a consumed virtual resource and radio resource of each of the target gNBs, a projected virtual resource and radio resource usage in near future for each of the target gNBs, an indication on whether at least one target gNB from the plurality of target gNBs is optimal for handover, at least one of in present and in future (with time stamp) and at least one corrective action to optimize each of the target gNBs for handover.

Further, the method includes receiving, by the source gNB, the analytical report of the at least one target gNB from the MDAS server. Further, the method includes performing, by the source gNB, the at least one corrective action to optimize at least one target gNB for handover. Further, the method includes determining, by the source gNB, whether at least one target gNB from the plurality of target gNBs is optimal for handover at present or at some future point of time. Further, the method includes performing, by the source gNB, the handover from the source gNB to the at least one target gNB in response to determining that the at least one target gNB from the plurality of target gNBs is optimal for handover at present or at some future point of time. Further, the method includes sending, by the source gNB, a scale-out request to an NFMS server (i.e. Network Function Management Service producer) to increase virtual resources and radio resources associated with the at least one target gNB in response to determining that the at least one target gNB from the plurality of target gNBs is not optimal for handover.

In an embodiment, sending the scale-out request to the NFMS server, further includes allocating, by the NFMS server, additional virtual resources and radio resources to the at least one target gNB. Further, the scale-out request includes informing, by the NFMS server, successful scale-out of the at least one target gNB to the source gNB. Further, the scale-out request includes determining, by the source gNB, whether a user equipment (UE) is moving away from the target gNB in the wireless network.

In an embodiment, determining, by the source gNB, whether the UE is moving away from the target gNB in the wireless network, includes performing, by the source gNB, the handover from the source gNB to the at least one target gNB in response to determining that the UE is not moving away from the target gNB in the wireless network, and sending, by the source gNB, a scale-in request to the NFMS server to decrease virtual resources and radio resources associated with the at least one target gNB in response to determining that the UE is moving away from the target gNB in the wireless network.

In an embodiment, sending the scale-out request to the NFMS server, further includes de-allocating, by the NFMS server, additional virtual resources and radio resources to the at least one target gNB. Further, the scale-in request includes informing, by the NFMS server, successful scale-in of the at least one target gNB to the source gNB. The radio resources decrease in the same proportion as they were increase.

In an embodiment, the MDAS server provides the analytical report describing the resource consumption to the source gNB (e.g. authorized consumer) based on the current and future virtual resource consumption of the at least one target gNB.

In an embodiment, the MDAS server provides the analytical report describing the resource consumption to the authorized consumer based on the current and future radio resource consumption of the at least one target gNB.

In an embodiment, the MDAS server generating the analytical report using at least one of an Artificial Intelligence (AI) model and a Machine Learning (ML) model.

Accordingly, the embodiments herein provide a method for MDAS server assisted handover optimization in a wireless network, the wireless network comprises a plurality of gNBs. The method includes detecting, by a source gNB from the plurality of gNBs that a UE moves from at least one target gNB from a plurality of target gNBs in the wireless network. Further, the method includes sending, by the source gNB, a request to an MDAS server for an analytical report of the at least one target gNB for handover from the source gNB, where the analytical report comprises at least one a current resource consumption status for each of the target gNBs, a future resource consumption status for each of the target gNBs. Further, the method includes an indication on whether at least one target gNB from the plurality of target gNBs is optimal for handover at present or at some future point of time and at least one corrective action to optimize at least one target gNB for handover. Further, the method includes receiving, by the source gNB, the analytical report of the at least one target gNB from the MDAS server. Further, the method includes performing, by the source gNB, at least one corrective action to optimize at least one target gNB for handover.

Accordingly, the embodiments herein provide the MDAS server for providing an optimal handover in the wireless network. The MDAS server includes an analytical report generator coupled with a processor and a memory. The analytical report generator is configured to periodically collect data from a plurality of target gNBs in the wireless network. Further, the analytical report generator is configured to generate an analytical report for each target gNB of the plurality of target gNBs based on the collected data. Further, the analytical report generator is configured to receive a request for the analytical report of the at least one target gNB for handover from a source gNB from the plurality of target gNBs. Further, the analytical report generator is configured to send the analytical report to the source gNB.

Accordingly, the embodiments herein provide the source gNB for providing an optimal handover in the wireless network. The source gNB includes a corrective action controller coupled with a processor and a memory. The corrective action controller is configured to detect that a user equipment (UEL) moves from at least one target gNB from the plurality of target gNBs in the wireless network. Further, the corrective action controller is configured to send a request to an MDAS server for an analytical report of the at least one target gNB for handover from the source gNB. Further, the corrective action controller is configured to receive the analytical report of the at least one target gNB from the MDAS server. Further, the corrective action controller is configured to perform at least one corrective action to optimize at least one target gNB for handover.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The principal object of the embodiments herein is to provide a method for Management data analytic service (MDAS) server assisted handover optimization in a wireless network.

### BRIEF DESCRIPTION OF DRAWINGS

This method and system is illustrated in the accompanying drawings, throughout which like reference letters indicate corresponding parts in the various figures. The embodiments herein will be better understood from the following description with reference to the drawings, in which:

FIG. 1 is an overall architecture of a MDAS server assisted handover optimization in a wireless network, according to the embodiments as disclosed herein;

FIG. 2A illustrates a block diagram of the MDAS server for providing an optimal handover in a wireless network, according to the embodiments as disclosed herein;

FIG. 2B illustrates a block diagram of a source gNB for providing an optimal handover in the wireless network, according to the embodiments as disclosed herein;

FIG. 3A is a flow diagram illustrating various operations for the MDAS server assisted handover optimization in the wireless network, according to the embodiments as disclosed herein;

FIG. 3B is a flow diagram illustrating various operations for the MDAS server assisted handover optimization in the wireless network, according to the embodiments as disclosed herein;

FIG. 3C is a flow diagram illustrating various operations for the MDAS server assisted handover optimization in the wireless network, according to the embodiments as disclosed herein;

FIG. 4A is a sequential diagram illustrating the MDAS server assisted handover optimization in the wireless network, according to the embodiments as disclosed herein; and

FIG. 4B is a sequential diagram illustrating the MDAS server assisted handover optimization in the wireless network, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for Management data analytic service (MDAS) server assisted handover optimization in a wireless network. The method is desirable to use an MDAS server to provision/select a particular gNB for a handover to avoid handover rejections. The MDAS server can collect several resource-specific (e.g. virtual resource, RAN resource) data from a plurality of gNB(s) periodically, analyze the data and then create a comprehensive analytical report for the gNB(s) providing current resource status for a target gNB. The analytical report also indicated whether the target gNB is optimal for handover at present (current optimal target) or at some future point of time (future optimal target). If the target gNB is not optimal for handover, the analytical report provides recommended actions to optimize the target gNB for the handover. A source gNB, acting as an MDAS consumer, can request for the analytical report before executing handover. If the target gNB is not optimal for handover, the MDAS consumer may choose to take/perform the corrective measures as suggested in the analytical report before continuing with the handover procedures. Further, the analytical report also includes future/expected resource consumption information for the target gNB/gNB(s) at a future point of time. The MDAS consumer may choose either not to proceed with the handover if the report is suggesting a near future resource deprivation at the target gNB or take corrective actions to optimize the target gNB for handover.

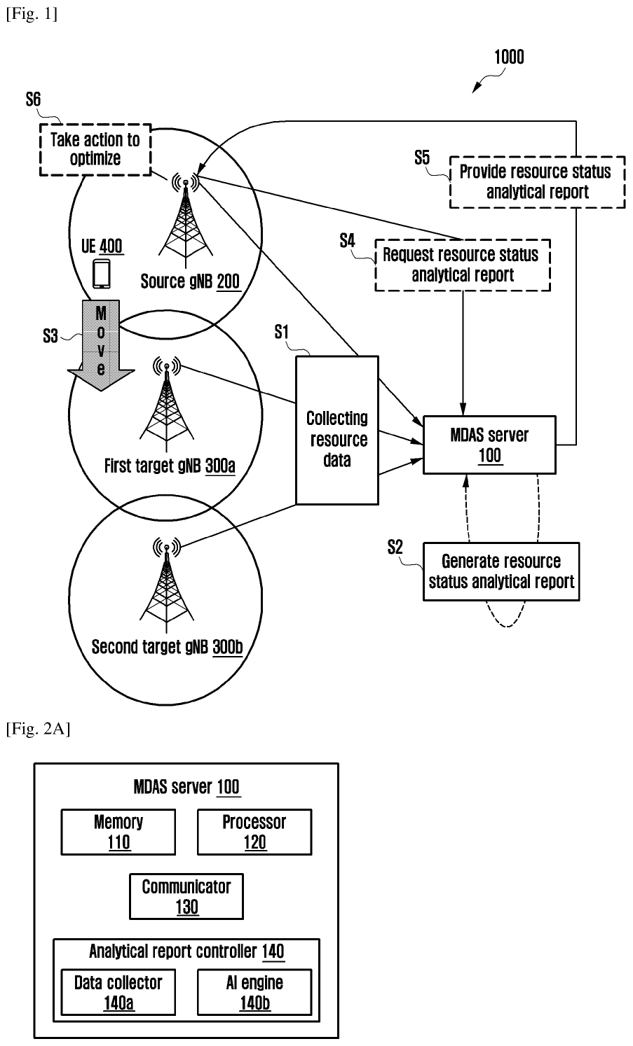

Referring now to the drawings, and more particularly to FIGS. 1 through 4, where similar reference characters denote corresponding features consistently throughout the figures, there are shown preferred embodiments.

FIG. 1 is an overall architecture of a MDAS server (100) assisted handover optimization in a wireless network (1000), according to the embodiments as disclosed herein. The wireless network (1000) includes the MDAS server (100), a source gNB (200), and a plurality of target gNBs (at least one target gNB (300)), a UE (400), and a NFMS server (500).

At S1, the MDAS server (100) periodically collects data from the plurality of gNBs (i.e. the target gNB (300) (e.g. a first target gNB (300a), and a second target gNB (300b)) in the wireless network (1000). Details about the data is given in the Table. 1.

TABLE 1

| Data | Description |
|---|---|
| Compute | This describes the number of vCPUs (Openstack Nova) |
| allocated | allocated to the virtual machine on which the gNB VNF is |
| | hosted. |
| Compute | This describes the number of total aggregated compute |
| consumed | resource (vCPU) consumption at a particular point of time. |
| Storage | This describes the number of vStorage (Openstack Cinder) |
| allocated | allocated to the virtual machine on which the gNB VNF is |
| | hosted. |
| Storage | This describes the number of total aggregated storage |
| consumed | consumption at a particular point of time. |
| Radio | This describes various radio resource and their overall |
| Resource | consumption percentage. |
| consumed | |

At S2, the MDAS server (100) generates the analytical report for each target gNB (300) of the plurality of target gNBs (300a, 300b) based on the collected data. The data is then analyzed using various AI mechanism to ascertain whether the first target gNB (300a) is deprived of resources or not. In case, the first target gNB (300a) is deprived of resources the report provides recommended actions e.g. in case of virtual resource deprivation, the scale-out/up will be suggested. The MDAS server (100) has a capability allowing the source gNB (200) (authorized consumer) to get the analytical report describing the resource consumption for each gNB (300a, 300b). Further, the MDAS server (100) can provide the analytical report describing the resource consumption to the authorized consumer based on the current and future virtual resource consumption of each target gNB (300a, 300b). Further, the MDAS server (100) can provide the analytical report describing the resource consumption to the authorized consumer based on the current and future RAN resource consumption of each target gNB (300a, 300b). Further, the analytical report describing resource consumption should contain the following information describing the current and future resource consumption,

Assigned virtual resources and radio resources.

Consumed virtual resources and radio resources.

Projected virtual resources and radio resources usage in near future.

Indication on whether the target gNB is optimal for handover at present (current optimal target) or at some future point of time (future optimal target).

Recommended action to optimize the gNB for handover.

At S3, the source gNB (200) detects that the UE (400) moves towards at least one target gNB (300) (i.e. the first target gNB (300a)) from the plurality of target gNBs in the wireless network (1000). At S4, the MDAS server (100) receives a request for the analytical report of the at least one target gNB (300) (i.e. the first gNB (300a)) for handover from the source gNB (200) from the plurality of target gNBs. At S5, the MDAS server (100) sends the analytical report to the source gNB (200). At S6, the source gNB (200) (MDAS consumer) adjusts (e.g. scale-out/up) the resources before continuing with the handover.

FIG. 2A illustrates a block diagram of the MDAS server (100) for providing an optimal handover in the wireless network (1000), according to the embodiments as disclosed herein. In an embodiment, the MDAS server (100) includes a memory (110), a processor (120), a communicator (130), and an analytical report controller (140).

The memory (110) also stores instructions to be executed by the processor (120). The memory (110) may include non-volatile storage elements. Examples of such nonvolatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In certain examples, a nontransitory storage medium may store data that can, over time, change (e.g., in Random Access Memory (RAM) or cache). In an embodiment, the memory (110) can be an internal storage unit or it can be an external storage unit of the MDAS server (100), a cloud storage, or any other type of external storage.

The processor (120) communicates with the memory (110), the communicator (130), and the analytical report controller (140). The processor (120) is configured to execute instructions stored in the memory (110) and to perform various processes. The communicator (130) is configured for communicating internally between internal hardware components and with external devices via one or more networks.

In an embodiment, the analytical report controller (140) includes a data collector (140a), and an AI engine (140b). The data collector (140a) periodically collects data from the plurality of gNBs (e.g. the target gNB (300)) in the wireless network (1000). Further, the analytical report controller (140) generates an analytical report for each target gNB (300) of the plurality of target gNBs based on the collected data, where the analytical report comprises at least one a current resource consumption status for each of the target gNBs, a future resource consumption status for each of the target gNBs (300), an indication on whether at least one target gNB (300) (e.g. the first target node (300a), the second target node (300b), etc.) from the plurality of target gNBs is optimal for handover at present (current optimal target) or at some future point of time (future optimal target) and at least one corrective action to optimize at least one target gNB (300) for handover. Further, the analytical report controller (140) receives a request for the analytical report of the at least one target gNB (300) for handover from a source gNB (200). Further, the analytical report controller (140) sends the analytical report to the source gNB (200).

In an embodiment, the collected data comprises a total amount of computed resource allocated to a virtual machine, a total amount of aggregated computed resource consumption at a particular point, a total amount of storage allocated to the virtual machine, a total amount of aggregated storage consumption at a particular point of time, and various radio resources and percentage of overall consumption of the various radio resources.

In an embodiment, the current resource consumption status for each of the target gNBs and the future resource consumption status for each of the target gNBs comprises an assigned virtual resource and radio resource of each of the target gNBs, a consumed virtual resource and radio resource of each of the target gNBs, a projected virtual resource and radio resource usage in near future for each of the target gNBs, an indication on whether at least one target gNB (300) from the plurality of target gNBs is optimal for handover at present (current optimal target) or at some future point of time (future optimal target), and at least one corrective action to optimize each of the target gNBs for handover.

In an embodiment, the analytical report controller (140) provides the analytical report describing the resource consumption to the authorized consumer based on the current and future virtual resource consumption of the at least one target gNB (300).

In an embodiment, the analytical report controller (140) provides the analytical report describing the resource consumption to the authorized consumer based on the current and future radio resource consumption of the at least one target gNB (300).

In an embodiment, the analytical report controller (140) generates the analytical report using at least one of an Artificial Intelligence (AI) model and a Machine Learning (ML) model. The AI engine (140b) utilizing collected data and AI/ML (for example, time series based) algorithm to derive the future handover optimality.

At least one of the plurality of modules/components may be implemented through an AI model. A function associated with AI may be performed through memory (110) and the processor (120).

The processor (120) may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors controls the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 2A shows various hardware components of the MDAS server (100) but it is to be understood that other embodiments are not limited thereon. In other embodiments, the MDAS server (100) may include less or more number of components. Further, the labels or names of the components are used only for illustrative purpose and does not limit the scope of the invention. One or more components can be combined together to perform same or substantially similar function for MDAS server (100) assisted handover optimization in the wireless network (1000).

FIG. 2B illustrates a block diagram of the source gNB (200) for providing the optimal handover in the wireless network (1000), according to the embodiments as disclosed herein. In an embodiment, the source gNB (200) includes a memory (210), a processor (220), a communicator (230), and a corrective action controller (240).

The memory (210) also stores instructions to be executed by the processor (220). The memory (210) may include non-volatile storage elements. Examples of such nonvolatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In certain examples, a nontransitory storage medium may store data that can, over time, change (e.g., in Random Access Memory (RAM) or cache). In an embodiment, the memory (210) can be an internal storage unit or it can be an external storage unit of the source gNB (200), a cloud storage, or any other type of external storage.

The processor (220) communicates with the memory (210), the communicator (230), and the corrective action controller (240). The processor (220) is configured to execute instructions stored in the memory (210) and to perform various processes. The communicator (230) is configured for communicating internally between internal hardware components and with external devices via one or more networks.

In an embodiment, the corrective action controller (240) detects that a UE (400) moves towards at least one target gNB (300) from the plurality of target gNBs in the wireless network (1000). Further, the corrective action controller (240) sends a request to a MDAS server (100) for the analytical report of the at least one target gNB (300) for handover from the source gNB (200), where the analytical report comprises at least one a current resource consumption status for each of the target gNBs, a future resource consumption status for each of the target gNBs, an indication on whether at least one target gNB (300) from the plurality of target gNBs is optimal for handover at present (current optimal target) or at some future point of time (future optimal target), and at least one corrective action to optimize at least one target gNB (300) for handover. Further, the corrective action controller (240) receives the analytical report of the at least one target gNB (300) from the MDAS server (100). Further, the corrective action controller (240) performs at least one corrective action to optimize at least one target gNB (300) for handover.

In an embodiment, the corrective action controller (240) determines whether at least one target gNB (300) from the plurality of target gNBs is optimal for handover. Further, the corrective action controller (240) performs the handover from the source gNB (200) to the at least one target gNB (300) in response to determining that the at least one target gNB (300) from the plurality of target gNBs is optimal for handover. Further, the corrective action controller (240) sends a scale-out request to an NFMS server (500) to increase virtual resources and radio resources associated with the at least one target gNB (300) in response to determining that the at least one target gNB (300) from the plurality of target gNBs is not optimal for handover.

Further, the corrective action controller (240) determines whether the UE (400) is moving away from the target gNB (300) in the wireless network (1000). Further, the corrective action controller (240) performs the handover from the source gNB (200) to the at least one target gNB (300) in response to determining that the UE (400) is not moving away from the target gNB (300) in the wireless network (1000). Further, the corrective action controller (240) sends a scale-in request to the NFMS server (500) to decrease virtual resources and radio resources associated with the at least one target gNB (300) in response to determining that the UE (400) is moving away from the target gNB (300) in the wireless network (1000).

Although the FIG. 2B shows various hardware components of the source gNB (200) but it is to be understood that other embodiments are not limited thereon. In other embodiments, the source gNB (200) may include less or more number of components. Further, the labels or names of the components are used only for illustrative purpose and does not limit the scope of the invention. One or more components can be combined together to perform same or substantially similar function for MDAS server (100) assisted handover optimization in the wireless network (1000).

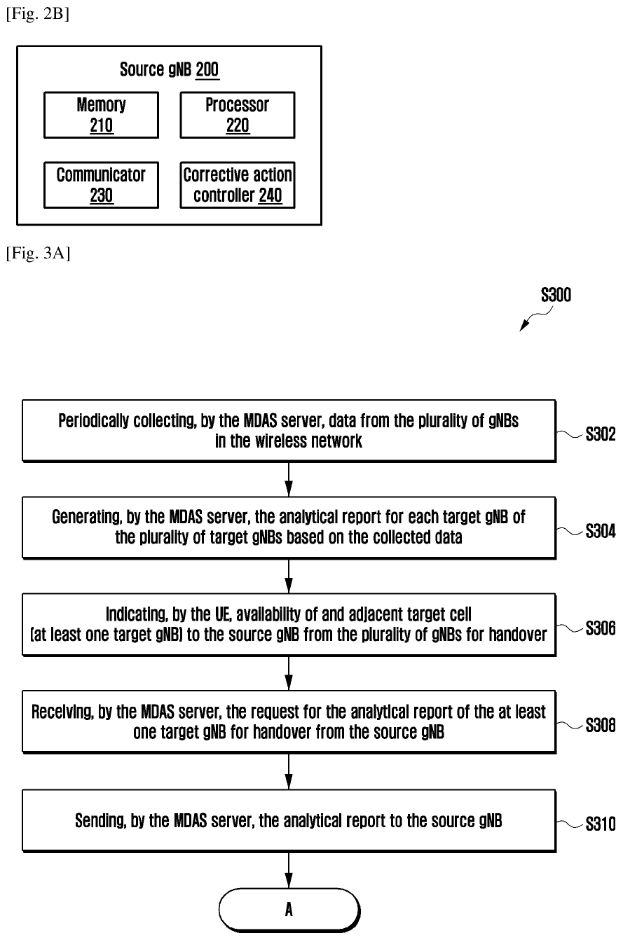

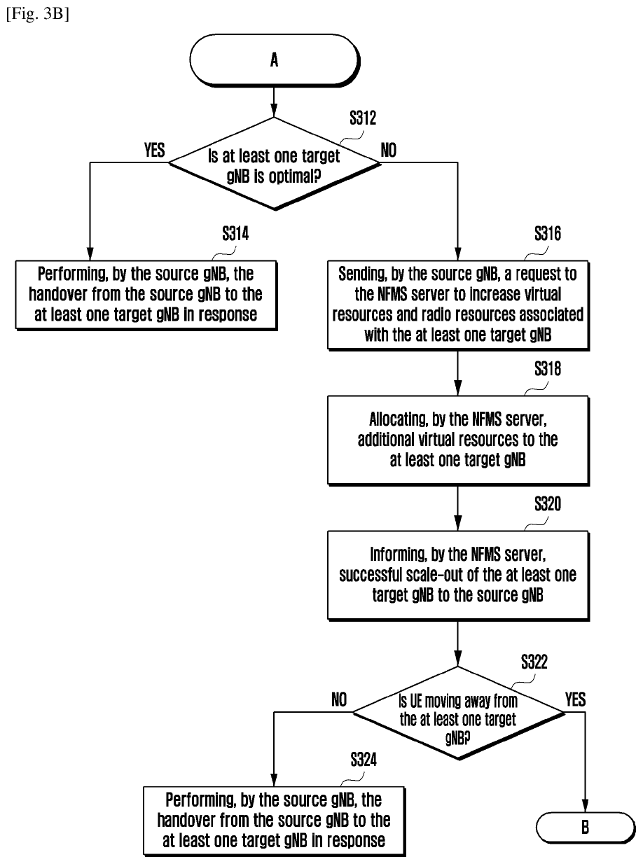

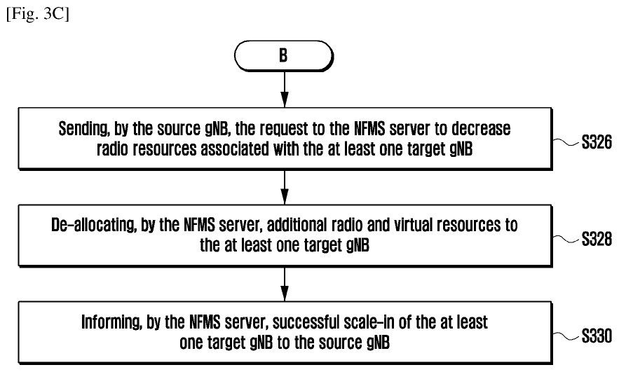

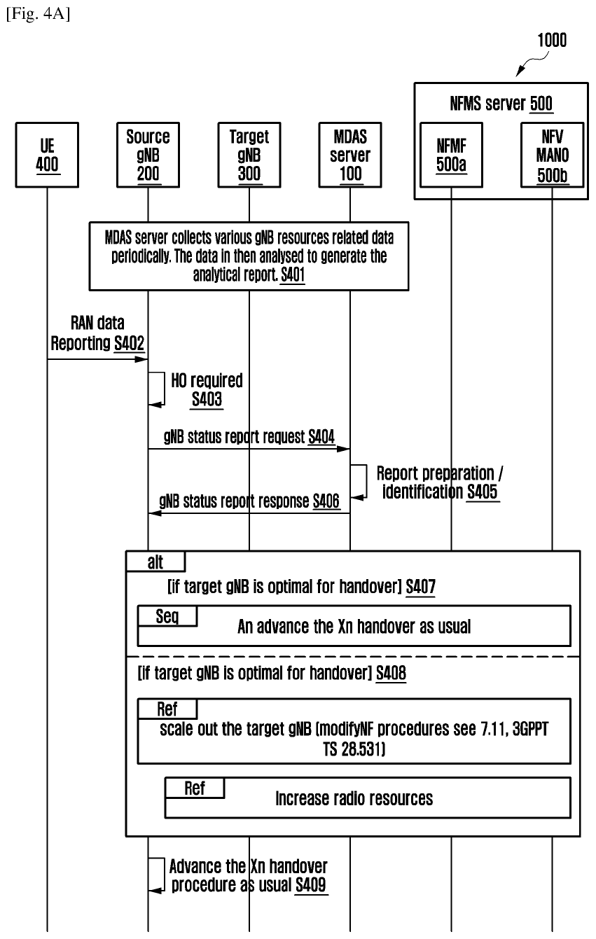

FIGS. 3A, 3B, and, 3C illustrate various operations for the MDAS server (100) assisted handover optimization in the wireless network (1000), according to the embodiments as disclosed herein.

At S302, the method includes periodically collecting, by the MDAS server (100), data from the plurality of target gNBs in the wireless network (1000). At S304, the method includes generating, by the MDAS server (100), the analytical report for each target gNB (300) of the plurality of target gNBs based on the collected data. At S306, the method includes indicating, by the UE (400), availability of an adjacent target cell (at least one target gNB (300)) from the source gNB (200) from the plurality of target gNBs for handover. At S308, the method includes receiving, by the MDAS server (100), the request for the analytical report of the at least one target gNB (300) for handover from the source gNB (100). At S310, the method includes sending, by the MDAS server (100), the analytical report to the source gNB (200). At 3212, the method includes determining, by the source gNB (200), whether at least one target gNB (300) from the plurality of target gNBs is optimal for handover at present or at some future point of time.

At S314, the method includes performing, by the source gNB (200), the handover from the source gNB (200) to the at least one target gNB (300) in response to determining that the at least one target gNB (300) from the plurality of target gNBs is optimal for handover. At S316, the method includes sending, by the source gNB (200), the scale-out request to the NFMS server (500) to increase virtual resources and radio resources associated with the at least one target gNB (300) in response to determining that the at least one target gNB (300) from the plurality of target gNBs is not optimal for handover. At S318, the method includes allocating, by the NFMS server (500), additional virtual resource and radio resources to the at least one target gNB (300). At S320, the method includes informing, by the NFMS server (500), successful scale-out of the at least one target gNB (300) to the source gNB (200). At S322, the method includes determining, by the source gNB (200), whether the UE (400) is moving away from the target gNB (300) in the wireless network (1000).

At S324, the method includes performing, by the source gNB (200), the handover from the source gNB (200) to the at least one target gNB (300) in response to determining that the UE (400) is not moving away from the target gNB (300) in the wireless network (1000). At S326, the method includes sending, by the source gNB (200), the scale-in request to the NFMS server (500) to decrease virtual resources and radio resources associated with the at least one target gNB (300) in response to determining that the UE (400) is moving away from the target gNB (300) in the wireless network (1000). At S328, the method includes de-allocating, by the NFMS server (500), additional radio resources to the at least one target gNB (300). At S330, the method includes informing, by the NFMS server (500), successful scale-in of the at least one target gNB (300) to the source gNB (200).

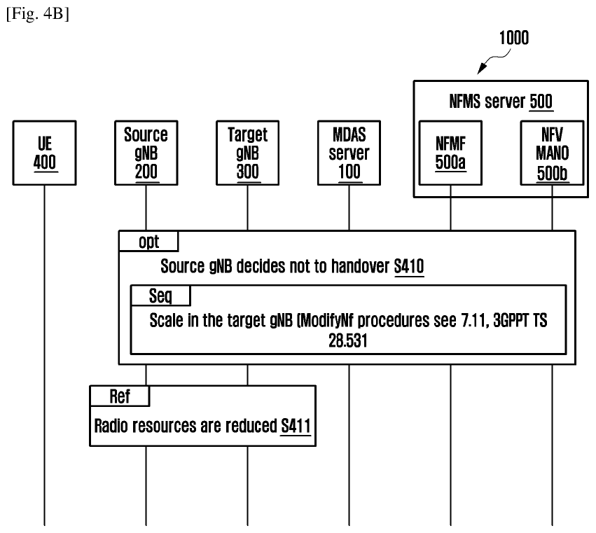

FIG. 4A and FIG. 4B illustrate the MDAS server (100) assisted handover optimization in the wireless network (1000), according to the embodiments as disclosed herein.

At 401, the MDAS server (100) collects various gNB resources related data periodically. The data is then analyzed to generate the analytical report. At 402, the UE (400) sends RAN data to the source gNB (200) and indicates availability of the adjacent target cell (e.g. target gNB (300)) to the source gNB (200) for handover. At 403, the source gNB (200) determines handover is required for the UE (400) and the source gNB (200) identifies the target gNB (300). At 404, the source gNB (200) sends the request for a resource analytics report for the target gNB (300) to the MDAS server (100) (i.e. MDAS producer). At 405, the MDAS server (100) identifies and prepares the related report. At 406, the MDAS server (100) provides the target gNB (300) resource analytics report containing an assigned virtual resource and radio resource, a consumed virtual resource and radio resource, a projected virtual and RAN resource usage in near future, a current optimal target (i.e. YES/NO), a future optimal target (i.e. YES/NO)/future timestamp and remedial action (e.g. scale-out gNB, increase radio resource (RRC connected users, PDCP).

At 407, when the target gNB (300) is optimal for handover, advances the handover procedures as usual. At 408, when the target gNB (300) is not optimal for handover, scale-out the target gNB (300). The source gNB (200) acting as NFMS consumer, sends ModifyNf request (section 7.11, 3GPP TS 28.531) to NFMS producer (the NFMS server (500), the NFMS server (500) includes a NFMF (500a), and a NFV MANO (500b)) to scale-out the target gNB (300 allocating additional virtual resources to the target gNB (300). Further, the NFMS producer confirms the successfully scaleout of the target gNB (300) to the source gNB (200) and increase virtual resources and radio resources of the target gNB (300). At 409, the source gNB (200) performs advances in the handover procedures as usual.

At 410, if the source gNB (200) decides not to handover (because of the UE (400) is moving away from the target gNB (200) or something else), the NFMS consumer sends ModifyNf request (section 7.11, 3GPP TS 28.531) to the NFMS producer to scale-in the target gNB (200). Further, the NFMS producer de-allocate additional virtual resources to the target gNB (200). Further, the NFMS producer confirms the successfully scale-in of the target gNB (300) to source gNB (200). At 411, radio resources are reduced in proportion with the increase done.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for a Management data analytic service (MDAS) server (100) assisted handover in a wireless network (1000), the method comprises:
collecting, by the MDAS server (100), data from a plurality of target gNBs in the wireless network (1000);
generating, by the MDAS server (100), an analytical report for each target gNB (300) of the plurality of target gNBs based on the collected data, wherein the analytical report comprises at least one a current resource consumption status for each of the target gNBs, a future resource consumption status for each of the target gNBs, an indication on whether at least one target gNB (300) from the plurality of target gNBs is optimal for handover, and at least one corrective action to optimize at least one target gNB (300) for handover;
receiving, by the MDAS server (100), a request for the analytical report of the at least one target gNB (300) for handover from a source gNB (200); and
sending, by the MDAS server (100), the analytical report to the source gNB (200).

2. The method as claimed in claim 1, wherein the collected data comprises a total amount of computed resource allocated to a virtual machine, a total amount of aggregated computed resource consumption at a particular point, a total amount of storage allocated to the virtual machine, a total amount of aggregated storage consumption at a particular point of time, and various radio resources and percentage of overall consumption of the various radio resources.

3. The method as claimed in claim 1, wherein the analytical report comprises an assigned virtual resource and radio resource of each of the target gNBs, a consumed virtual resource and radio resource of each of the target gNBs, a projected virtual resource and radio resource usage in near future for each of the target gNBs, an indication on whether at least one target gNB (300) from the plurality of target gNBs is optimal for handover for at least one of present time and future time with timestamp, and at least one corrective action to optimize each of the target gNBs for handover.

4. The method as claimed in claim 1, further comprises:
receiving, by the source gNB (200), the analytical report of the at least one target gNB (300) from the MDAS server (100); and
performing, by the source gNB (200), the at least one corrective action to optimize at least one target gNB (300) for handover.

5. A method for Management data analytic service (MDAS) server (100) assisted handover in a wireless network (1000), wherein the wireless network (1000) comprises a plurality of gNBs, the method comprises:
detecting, by a source gNB (200) from the plurality of gNBs, that a user equipment (UE) moves towards at least one target gNB (300) from a plurality of target gNBs in the wireless network (1000);
sending, by the source gNB (200), a request to an MDAS server (100) for an analytical report of the at least one target gNB (300) for handover from the source gNB (200), wherein the analytical report comprises at least one a current resource consumption status for each of the target gNBs, a future resource consumption status for each of the target gNBs, an indication on whether at least one target gNB (300) from the plurality of target gNBs is optimal for handover, and at least one corrective action to optimize at least one target gNB (300) for handover;
receiving, by the source gNB (200), the analytical report of the at least one target gNB (300) from the MDAS server (100); and
performing, by the source gNB (200), at least one corrective action to optimize at least one target gNB (300) for handover.

6. The method as claimed in claim 5, wherein performing the at least one corrective action to optimize at least one target gNB (300) for handover, comprises:
determining, by the source gNB (200), whether at least one target gNB (300) from the plurality of target gNBs is optimal for handover; and
performing one of:
performing, by the source gNB (200), the handover from the source gNB (200) to the at least one target gNB (300) in response to determining that the at least one target gNB (300) from the plurality of target gNBs is optimal for handover, and
sending, by the source gNB (200), a scale-out request to an NFMS server (500) to increase virtual resources and radio resources associated with the at least one target gNB (300) in response to determining that the at least one target gNB (300) from the plurality of target gNBs is not optimal for handover.

7. The method as claimed in claim 6, wherein sending the scale-out request to the NFMS server (500), further comprises:
allocating, by the NFMS server (500), additional virtual resources and radio resources to the at least one target gNB (300);
informing, by the NFMS server (500), successful scale-out of the at least one target gNB (300) to the source gNB (200); and
determining, by the source gNB (200), whether a user equipment (UE) is moving away from the target gNB (300) in the wireless network (1000).

8. The method as claimed in claim 7, wherein determining, by the source gNB (200), whether the UE (400) is moving away from the target gNB (300) in the wireless network (1000), comprises:
performing, by the source gNB (200), one of:
performing, by the source gNB (200), the handover from the source gNB (200) to the at least one target gNB (300) in response to determining that the UE (400) is not moving away from the target gNB (300) in the wireless network (1000), and
sending, by the source gNB (200), a scale-in request to the NFMS server (500) to decrease virtual resources and radio resources associated with the at least one target gNB (300) in response to determining that the UE (400) is moving away from the target gNB (300) in the wireless network (1000).

9. A Management data analytic service (MDAS) server (100) for optimal handover in a wireless network (1000), the MDAS server (100) comprises:
a memory (110);
a processor (120) coupled with the memory (110); and
an analytical report controller (140), coupled with the processor (120), configured to:
collect data from a plurality of target gNBs in the wireless network (1000);
generate an analytical report for each target gNB (300) of the plurality of target gNBs based on the collected data, wherein the analytical report comprises at least one a current resource consumption status for each of the target gNBs, a future resource consumption status for each of the target gNBs, an indication on whether at least one target gNB (300) from a plurality of target gNBs is optimal for handover, and at least one corrective action to optimize at least one target gNB (300) for handover;
receive a request for the analytical report of the at least one target gNB (300) for handover from a source gNB (200); and
send the analytical report to the source gNB (200).

10. The MDAS server (100) as claimed in claim 9, wherein the collected data comprises a total amount of computed resource allocated to a virtual machine, a total amount of aggregated computed resource consumption at a particular point, a total amount of storage allocated to the virtual machine, a total amount of aggregated storage consumption at a particular point of time, and various radio resources and percentage of overall consumption of the various radio resources.

11. The MDAS server (100) as claimed in claim 9, wherein the analytical report comprises an assigned virtual resource and radio resource of each of the target gNBs, a consumed virtual resource and radio resource of each of the gNBs target, a projected virtual resource and radio resource usage in near future for each of the target gNBs, an indication on whether at least one target gNB (300) from the plurality of target gNBs is optimal for handover for at least one of present and in future time stamp, and at least one corrective action to optimize each of the target gNBs for handover.

12. The MDAS server (100) as claimed in claim 9, wherein the MDAS server (100) provides the analytical report describing the resource consumption to the source gNB (200) based on the current and future virtual resource consumption of the at least one target gNB (300).

13. A source gNB (200) for optimal handover in a wireless network (1000), the source gNB (200) comprises:
a memory (210);
a processor (220) coupled with the memory (210); and
a corrective action controller (240), coupled with the processor (220), configured to:
detect that a user equipment (UE) moves towards at least one target gNB (300) from a plurality of target gNBs in the wireless network (1000);
send a request to an MDAS server (100) for an analytical report of the at least one target gNB (300) for handover from the source gNB (200), wherein the analytical report comprises at least one a current resource consumption status for each of the target gNBs, a future resource consumption status for each of the target gNBs, an indication on whether at least one target gNB (300) from a plurality of target gNBs is optimal for handover, and at least one corrective action to optimize at least one target gNB (300) for handover;
receive the analytical report of the at least one target gNB (300) from the MDAS server (100); and
perform at least one corrective action to optimize at least one target gNB (300) for handover.

14. The source gNB (200) as claimed in claim 13, wherein perform the at least one corrective action to optimize at least one target gNB (300) for handover, comprises:
determining, by the source gNB (200), whether at least one target gNB (300) from the plurality of target gNBs is optimal for handover; and
performing one of:
performing, by the source gNB (200), the handover from the source gNB (200) to the at least one target gNB (300) in response to determining that the at least one target gNB (300) from the plurality of target gNBs is optimal for handover, and
sending, by the source gNB (200), a scale-out request to an NFMS server (500) to increase virtual resources and radio resources associated with the at least one target gNB (300) in response to determining that the at least one target gNB (300) from the plurality of target gNBs is not optimal for handover.

15. The source gNB (200) as claimed in claim 14, wherein sending the scale-out request to the NFMS server (500), further comprises:
allocating, by the NFMS server (500), additional virtual resources and radio resources to the at least one target gNB (300);
informing, by the NFMS server (500), successful scale-out of the at least one target gNB (300) to the source gNB (200); and
determining, by the source gNB (200), whether a user equipment (UE) is moving away from the target gNB (300) in the wireless network (1000).
